(19) United States
(12) Patent Application Publication
(10) Pub. No.: US 2019/0221022 A1
(43) Pub. Date: Jul. 18, 2019

(54) VIDEO GENERATION DEVICE, VIDEO GENERATION METHOD, AND VIDEO GENERATION PROGRAM

(71) Applicant: SHARP KABUSHIKI KAISHA, Sakai City, Osaka (JP)

(72) Inventors: KATSUYA KATO, Sakai City (JP); YASUHIRO HAMAGUCHI, Sakai City (JP)

(73) Assignee: SHARP KABUSHIKI KAISHA, Sakai City, Osaka (JP)

(21) Appl. No.: 16/307,041

(22) PCT Filed: May 31, 2017
(86) PCT No.: PCT/JP2017/020259

§ 371 Date: Dec. 4, 2018

(30) Foreign Application Priority Data
Jun. 6, 2016 (JP) 2016-112448

(51) Int. Cl. G06T 13/40; G06F 3/01; G06T 7/246; G06T 7/73

(52) U.S. Cl. CPC G06T 13/40; G06F 3/017; G06T 7/75; G06T 7/251; G06F 3/011

(57) ABSTRACT

A video generation device displays visual information as a result of inputting the movement of a user. The video generation device generates a video of a 3D virtual space, and includes: a movement detection unit configured to calculate a change in at least one of a position, an orientation, or an angle of the video generation device; an avatar data generation unit configured to generate first avatar data and second avatar data that are configured to include avatar coordinates, avatar motion, and model data in the 3D virtual space; an avatar data selection unit configured to select an avatar based on control data for controlling the avatar and data calculated by the movement detection unit; a 3D video generation unit configured to generate the 3D virtual space video based on data of the avatar selected and data calculated by the movement calculation unit; and a video display unit configured to display the video of the 3D virtual space.

### TECHNICAL FIELD

The present invention relates to a video generation device, a video generation method, and a video generation program.

### BACKGROUND ART

Wearable devices, such as eyeglass type terminals and smart glasses, have recently been receiving attention. PTL 1 discloses a display method in which a display object in a virtual space is displayed in an actual space and is used as an object to be operated.

### CITATION LIST

### Patent Literature

PTL 1: WO 2014/128787

### SUMMARY OF INVENTION

### Technical Problem

Unfortunately, the method disclosed in PTL 1 has a problem that an intentional operation of a user is required, where information, as a result of inputting the movement of the user, cannot be output so as to be easily recognized.

In light of the foregoing, an object of the present invention is to provide a video generation device, a video generation method, and a video generation program that display visual information as a result of inputting the movement of a user.

### Solution to Problem

To address the above-mentioned drawbacks, a video generation device, a video generation method, and a video generation program according to an aspect of the present invention are configured as follows.

A video generation device according to an aspect of the present invention generates a video of a 3D virtual space, the video generation device including: a movement detection unit configured to calculate a change in at least one of a position, an orientation, and an angle of the video generation device; an avatar data generation unit configured to generate first avatar data and second avatar data that are configured to include avatar coordinates, avatar motion, and model data in the 3D virtual space; an avatar data selection unit configured to select an avatar based on control data for controlling the avatar and data calculated by the movement detection unit; a 3D video generation unit configured to generate the video of the 3D virtual space based on data of the avatar selected and data calculated by the movement calculation unit; and a video display unit configured to display the video of the 3D virtual space.

In a video generation device according to an aspect of the present invention, the movement detection unit outputs data that includes a moving distance being the change in the position; and based on pace data for indicating a pace required for a user to keep and the change in the position, the avatar data selection unit selects the first avatar data in a case that a movement of the user satisfies the pace, and selects the second avatar data in a case that the movement of the user does not satisfy the pace.

In a video generation device according to an aspect of the present invention, the avatar data selection unit selects the first avatar data in a case that a number of visible satellites used by the movement detection unit is equal to or greater than a prescribed number, and selects the second avatar data in a case that the number of the visible satellites is less than the prescribed number.

In a video generation device according to an aspect of the present invention, a component of the avatar coordinates of the first avatar data in a traveling direction of the user differs from a component of the avatar coordinates of the second avatar data in the traveling direction of the user.

In a video generation device according to an aspect of the present invention, the avatar motion of the first avatar data differs from the avatar motion of the second avatar data.

In a video generation device according to an aspect of the present invention, the model data of the first avatar data differs from the model data of the second avatar data.

In a video generation device according to the present invention, a color configured by the model data of the first avatar data differs from a color configured by the model data of the second avatar data.

A video generation method according to an aspect of the present invention generates a video of a 3D virtual space, the video generation method including: a movement detecting step of calculating a change in at least one of a position, an orientation, and an angle of a device implementing the video generation method; an avatar data generating step of generating first avatar data and second avatar data that include avatar coordinates, avatar motion, and model data in the 3D virtual space; a 3D video generating step of generating the video of the 3D virtual space based on data calculated by the movement calculation unit; and a video displaying step of displaying the video of the 3D virtual space.

A video generation program according to an aspect of the present invention causes a computer to perform the above-described video generation method.

### Advantageous Effects of Invention

According to the present invention, the video generation device can display visual information as a result of inputting a movement of a user.

### BRIEF DESCRIPTION OF DRAWINGS

FIG. 1 is a schematic block diagram illustrating a configuration of a video generation device according to the present embodiment.

FIG. 2 is a diagram illustrating an example function according to the present embodiment.

FIG. 3 is a diagram illustrating an example video output by the video generation device according to the present embodiment.

### DESCRIPTION OF EMBODIMENTS

### First Embodiment

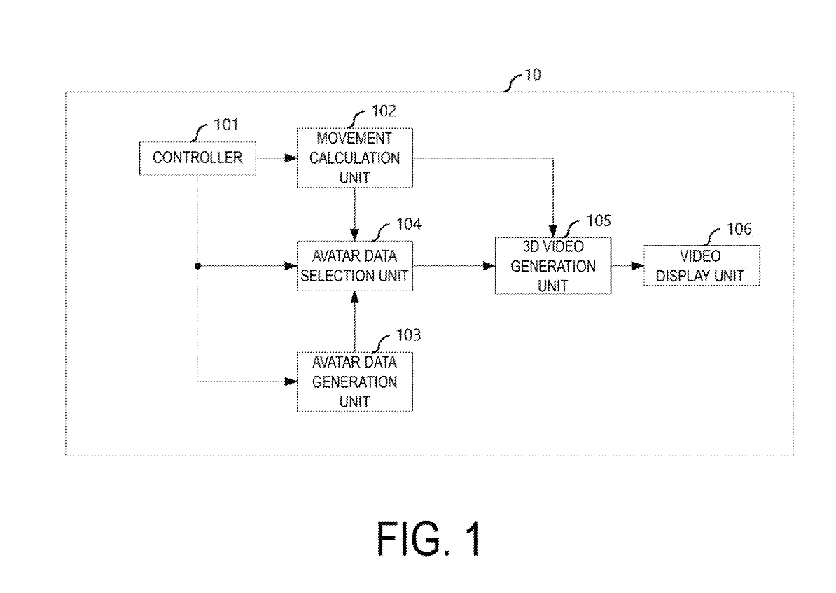

FIG. 1 is a diagram illustrating an example of a video generation device 10 according to the present embodiment. As illustrated in FIG. 1, the video generation device 10 according to the present embodiment is configured to include a controller (controlling step) 101, a movement calculation unit (movement calculating step) 102, an avatar data generation unit (avatar data generating step) 103, an avatar data selection unit (avatar data selecting step) 104, a 3D video generation unit (3D video generating step) 105, and a video display unit (video displaying step) 106. The video generation device 10 can be achieved by, for example, an eyeglass type terminal. Note that the video generation device 10 may not include the video display unit 106. For example, the video generation device 10 may just output a signal from the 3D video generation unit 105. In this case, for example, the video display unit 106 can constitute an eyeglass type terminal.

The controller 101 controls the video generation device 10. For example, the controller 101 outputs control data to control the movement calculation unit 102, the avatar data generation unit 103, and the avatar data selection unit 104. Although no arrows are illustrated in the drawing, the controller 101 can control the 3D video generation unit 105 and the video display unit 106.

The movement calculation unit 102 calculates a moving distance of the video generation device 10. The movement calculation can be achieved by a Global Positioning System (GPS) sensor, a Global Navigation Satellite System (GNSS) sensor, an Indoor Messaging System (IMES) sensor, a Bluetooth (trade name) sensor, an Ultra Wide Band (UWB) sensor, a wireless LAN sensor, an acoustic wave sensor, a visible light sensor, an infrared sensor, a rotation detection sensor, a magnetic field sensor, or the like. The movement calculation unit 102 outputs the calculated moving distance to the avatar data selection unit 104 and the 3D video generation unit 105.

Note that the movement calculation unit 102 may calculate not only a change of the position of the video generation device 10 but also the orientation or angle of the video generation device 10.

The avatar data generation unit 103 generates a position, an orientation, a velocity, quickness, a motion (avatar motion), model data, and the like of an avatar to be displayed on the video display unit 106. For example, the controller 101 can output pace data used for the avatar to move, to the avatar data generation unit 103. The avatar data generation unit 103 can generate a position, an orientation, a velocity, quickness, a motion, and the like of the avatar based on the input pace data. The avatar data generation unit 103 can generate first avatar data and second avatar data. The avatar data generation unit 103 outputs the first avatar data and the second avatar data to the avatar data selection unit 104.

The avatar data selection unit 104 selects either of the first avatar data and the second avatar data input by the avatar data generation unit 103 based on the moving distance input by the movement calculation unit 102. The avatar data selection unit 104 outputs the selected avatar data to the 3D video generation unit 105. For example, in a case that the moving distance satisfies the pace data determined by the controller 101, the avatar data generation unit 103 selects the first avatar data, and in a case that the moving distance does not satisfy the pace data, the avatar data generation unit 103 selects the second avatar data. Different pieces of avatar data allow the 3D video generation unit 105 to generate different videos. In this manner, the user wearing the video generation device 10 can know whether the user satisfies the pace data, based on the difference in the videos. Alternatively, the first avatar data or the second avatar data can be selected based on accuracy of the moving distance output by the movement calculation unit 102. In this manner, the user wearing the video generation device 10 can know accuracy of the moving distance of the user based on the difference in the videos. For example, in a case that the number of visible GNSS satellites is greater than a prescribed threshold, the avatar data selection unit 104 can select the first avatar data, and in a case that such a condition is not satisfied, the avatar data selection unit 104 can select the second avatar data. Note that the avatar data selection unit 104 may select the first avatar data or the second avatar data using the orientation or angle of the video generation device 10 input by the movement calculation unit 102. In this manner, the number of types of the movement of the user used as input can be increased.

The 3D video generation unit 105 generates a 3D video based on the moving distance input by the movement calculation unit 102 and the avatar data input by the avatar data selection unit 104. Specifically, the 3D video generation unit 105 can configure model data constituted by motion data for bones, bones, polygons, texture data, rigid body data for physics calculation, and the like. The 3D video generation unit 105 changes the model data to change how the avatar is displayed on the video display unit 106. The avatar data input by the avatar data selection unit 104 may include the model data. Specifically, one video is generated that is to appear on a camera in a case that the avatar in a 3D virtual space is projected on the camera. The 3D video generation unit 105 can determine coordinates of the camera based on the moving distance input by the movement calculation unit 102. Note that, in a case that the video display unit 106 is capable of stereoscopic display, two cameras may be configured from the moving distance input by the movement calculation unit 102, and two videos, having parallax, for the left eye and the right eye may be generated. The 3D video generation unit 105 outputs the one or two generated videos to the video display unit 106. Note that the 3D video generation unit 105 may generate a 3D video by using the orientation or angle of the video generation device 10 input by the movement calculation unit 102. In this manner, the display of the video can be more flexible.

The video display unit 106 displays the video input by the 3D video generation unit 105. For example, the video display unit 106 is mounted on an eyeglass type terminal or smart glasses. In this manner, the eyeglass type terminal can display the avatar in Augmented Reality (AR). In a case that the eyeglass type terminal has displays for both eyes and the 3D video generation unit 105 input two videos, the displays for the left eye and the right eye can display the respective videos.

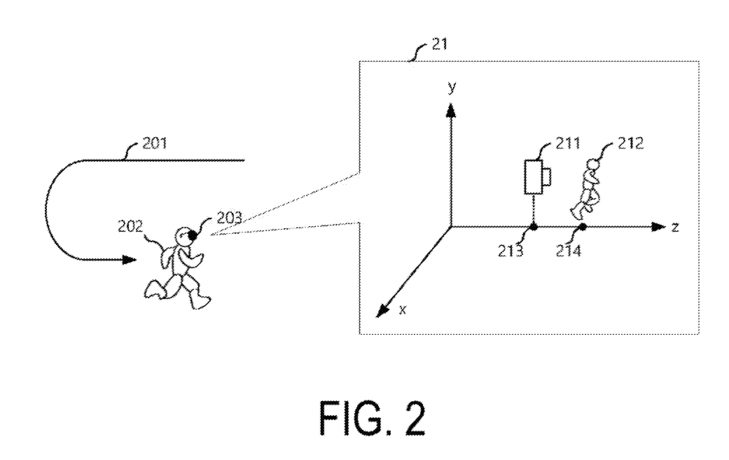

FIG. 2 illustrates an example function provided by the video generation device 10. FIG. 2 illustrates a state in which a user 202 runs along a route 201. The moving distance calculated by the movement calculation unit 102 in FIG. 1 can be regarded as the length of the route 201. The user 202 is wearing an eyeglass type terminal 203 being an example of the video generation device 10. A video displayed on a display (video display unit 106) of the eyeglass type terminal 203 is generated based on a 3D virtual space 21. In the virtual space 21, the x axis indicates a lateral direction, the y axis indicates a vertical direction, and the z axis indicates a forward direction. A camera 211 indicates the position and orientation of the eyeglass type terminal 203 in the virtual space. An avatar 212 moves with a configured pace in the z-axial direction in the virtual space. A coordinate 213 is the z coordinate of the camera 211. For example, the value of the coordinate 213 corresponds to the moving distance calculated by the movement calculation unit 102 in FIG. 1. A coordinate 214 is the z coordinate of the avatar 212 and varies at a configured pace. By displaying the video taken by the camera 211 on the display of the eyeglass type terminal 203, the user 202 can run as if the user runs after the avatar 212 in an actual space. Note that the avatar 212 can have a z coordinate which is 3 m greater than that of the user 202 in a case that the user 202 is running at an appropriate pace, for example. In this manner, even in a case that the eyeglass type terminal 203 has a narrow viewing angle, the above-described function can be achieved.

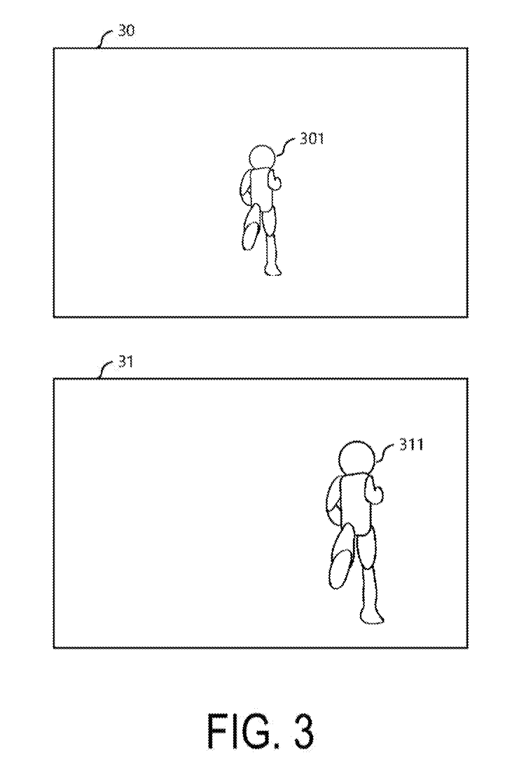

FIG. 3 illustrates an example case where the first avatar data and the second avatar data have different x coordinates, each x coordinate corresponding to the coordinate 214 in FIG. 2. A screen 30 illustrates an example case where the user is running at a pace behind the pace data, and an avatar 301 is displayed as if the avatar 301 is running at a distance in the forward direction. A screen 31 illustrates an example case where the user is running at a pace that satisfies the pace data, and an avatar 311 is displayed at a closer position and at a position shifted in the lateral direction. In this manner, even in a case that the avatar runs ahead of the user, the user can know whether the user is running at a pace that satisfies the pace data.

Note that the first avatar data and the second avatar data may have different colors. The first avatar data and the second avatar data may be based on different pieces of model data.

Note that, in a case that the number of GPS satellites or GNSS satellites visible from the video generation device 10 is less than a prescribed number, the above-described avatar data may be changed. In this manner, the user can know that the user is at a position where satellites are not visible. Whether the user satisfies the pace and whether the number of satellites visible from the video generation device 10 is sufficient may be output simultaneously as a video. For example, whether the user satisfies the pace may be displayed as illustrated in the example of FIG. 3, and whether the number of satellites is insufficient may be displayed by changing a color.

A program running on the video generation device or relating to the video generation method and the video generation program according to the present invention is a program (a program for causing a computer to operate) that controls a CPU and the like in such a manner as to realize the functions according to the above-described embodiment of the present invention. The information handled by these devices is temporarily held in a RAM at the time of processing, and is then stored in various types of ROMs, HDDs, and the like, and read out by the CPU as necessary to be edited and written. Here, a semiconductor medium (a ROM, a non-volatile memory card, or the like, for example), an optical recording medium (DVD, MO, MD, CD, BD, or the like, for example), a magnetic recording medium (a magnetic tape, a flexible disk, or the like, for example), and the like can be given as examples of recording media for storing the programs. In addition to realizing the functions of the above-described embodiments by executing loaded programs, the functions of the present invention are realized by the programs running cooperatively with an operating system, other application programs, or the like in accordance with instructions included in those programs.

In the case of delivering these programs to market, the programs can be stored in a portable recording medium, or transferred to a server computer connected via a network such as the Internet. In this case, the storage device serving as the server computer is also included in the present invention. Furthermore, some or all portions of each of the video generation device, the video generation method, and the video generation program in the above-described embodiment may be realized as LSI, which is a typical integrated circuit. The functional blocks of the reception device may be individually realized as chips, or may be partially or completely integrated into a chip. In a case that the functional blocks are integrated into a chip, an integrated circuit control unit for controlling them is added.

The circuit integration technique is not limited to LSI, and the integrated circuits for the functional blocks may be realized as dedicated circuits or a multi-purpose processor. Furthermore, in a case where with advances in semiconductor technology, a circuit integration technology with which an LSI is replaced appears, it is also possible to use an integrated circuit based on the technology.

Note that the invention of the present patent application is not limited to the above-described embodiments. It should be understood that the video generation device of the present application can be applied to not only a mobile station device but also a portable device, a wearable device, and the like.

The embodiments of the invention have been described in detail thus far with reference to the drawings, but the specific configuration is not limited to the embodiments. Other designs and the like that do not depart from the gist of the invention also fall within the scope of the claims.

### INDUSTRIAL APPLICABILITY

The present invention is suitable for use in a video generation device, a video generation method, and a video generation program.

The present international application claims priority based on JP 2016-112448 filed on Jun. 6, 2016, and all the contents of JP 2016-112448 are incorporated in the present international application by reference.

### REFERENCE SIGNS LIST

10 Video generation device
101 Controller
102 Movement calculation unit
103 Avatar data generation unit
104 Avatar data selection unit
105 3D video generation unit
106 Video display unit
201 Route
202 User
203 Eyeglass type terminal
21 Virtual space
211 Camera
212 Avatar
213, 214 Coordinate
30, 31 Screen
301, 311 Avatar

1. A video generation device for generating a video of a 3D virtual space, the video generation device comprising:
a movement detection unit configured to calculate a change in at least one of a position, an orientation, or an angle of the video generation device;
an avatar data generation unit configured to generate first avatar data and second avatar data that are configured to include avatar coordinates, avatar motion, and model data in the 3D virtual space;
an avatar data selection unit configured to select an avatar based on control data for controlling the avatar and data calculated by the movement detection unit;
a 3D video generation unit configured to generate the video of the 3D virtual space based on data of the avatar selected and data calculated by the movement calculation unit; and
a video display unit configured to display the video of the 3D virtual space.

2. The video generation device according to claim 1, wherein:
the movement detection unit outputs data that includes a moving distance being the change in the position; and
based on pace data for indicating a pace required for a user to keep and the change in the position, the avatar data selection unit selects the first avatar data in a case that a movement of the user satisfies the pace, and selects the second avatar data in a case that the movement of the user does not satisfy the pace.

3. The video generation device according to claim 1, wherein
the avatar data selection unit selects the first avatar data in a case that a number of visible satellites used by the movement detection unit is equal to or greater than a prescribed number, and selects the second avatar data in a case that the number of the visible satellites is less than the prescribed number.

4. The video generation device according to claim 1, wherein
a component of the avatar coordinates of the first avatar data in a direction other than a traveling direction of the user differs from a component of the avatar coordinates of the second avatar data in the direction other than the traveling direction of the user.

5. The video generation device according to claim 1, wherein
the avatar motion of the first avatar data differs from the avatar motion of the second avatar data.

6. The video generation device according to claim 1, wherein
the model data of the first avatar data differs from the model data of the second avatar data.

7. The video generation device according to claim 6, wherein
a color configured by the model data of the first avatar data differs from a color configured by the model data of the second avatar data.

8. A video generation method for generating a video of a 3D virtual space, the video generation method comprising:
calculating a change in at least one of a position, an orientation, and an angle of a device implementing the video generation method;
generating first avatar data and second avatar data that include avatar coordinates, avatar motion, and model data in the 3D virtual space;
generating the video of the 3D virtual space based on data calculated; and
displaying the video of the 3D virtual space.

9. A non-transitory computer readable recording medium storing instructions executable by a computer to perform at least:
calculating a change in at least one of a position, an orientation, and an angle of the computer;
generating first avatar data and second avatar data that include avatar coordinates, avatar motion, and model data in the 3D virtual space;
generating the video of the 3D virtual space based on data calculated; and
displaying the video of the 3D virtual space.
